(19) United States
(12) Patent Application Publication
(10) Pub. No.: US 2016/0170460 A1
(43) Pub. Date: Jun. 16, 2016

(54) BACKUP POWER KEYBOARD

(71) Applicants: Gregory Winfrey, Indianapolis, IN (US); Esther Winfield-Peyton, Indianapolis, IN (US)

(72) Inventors: Gregory Winfrey, Indianapolis, IN (US); Esther Winfield-Peyton, Indianapolis, IN (US)

(21) Appl. No.: 14/571,498

(22) Filed: Dec. 16, 2014

(51) Int. Cl. G06F 1/26; G06F 1/30

(52) U.S. Cl. CPC G06F 1/263; G06F 1/30; G06F 1/266

(57) ABSTRACT

A backup power keyboard for a computing device comprising a mobile keyboard, where the mobile keyboard is connected to the computing device; an internal battery within the mobile keyboard, where the internal battery is rechargeable; and a connector on the mobile keyboard, where the connector attaches the mobile keyboard to the computing device, wherein the internal battery powers the computing device through the connector when a battery within the computing device indicates LOW BATTERY.

### BACKGROUND OF THE INVENTION

1. Field of the Invention

The present invention relates to a mobile keyboard with an independent battery, that when needed by its attached computer serves as a backup battery.

2. Description of Related Art

Mobile computing devices are one of the most widely used tools on the market. Specifically, smartphones and tablets are all-in-one computing tools that allow a range of computing capabilities while also serving as a phone, camera, GPS and even pedometer. The larger screens of the tablets allow them to be widely used for both work and entertainment by enabling word processing and movie watching on a single device.

While these devices are easy to use, their battery life can be very short. Depending on the continuity of the use, the computing devices may last for a day or merely a few hours. If the use is sporadic then the tablet may only have to be charged every other day. If the person is always online or watching movies then the power will drain within a few hours requiring recharging about twice per day.

Due to how quickly many mobile computing devices lose their battery power, many devices have been developed as backup power sources. For example, most speakers will also charge the device while the smartphone is attached. Small backup batteries that connect into the power port of the smartphone may be used to add additional usage time for the tablet. Finally, some protective covers are also equipped with a backup battery that takes over as the power source once the first battery is drained.

While these backup power sources are useful they are not readily available for tablet or laptop computers. Therefore it would be beneficial in the art to provide a backup battery that is adaptable to both tablets and laptops.

### SUMMARY OF THE INVENTION

In view of the foregoing disadvantages inherent in the prior art, the general purpose of the present invention is to provide a backup power keyboard for a computing device, configured to include all of the advantages of the prior art, and to overcome the drawbacks inherent therein.

Accordingly, an object of the present invention is to provide a backup power keyboard that connects to a laptop, tablet or smartphone to serve as both a mobile keyboard and a backup battery.

Another object of the present invention is to provide a backup power keyboard that is activated when the LOW BATTERY indicator is triggered on the computing device.

To achieve the above objects, in an aspect of the present invention, a backup power keyboard is described comprising a mobile keyboard, where the mobile keyboard is connected to the computing device; an internal battery within the mobile keyboard, where the internal battery is rechargeable; and a connector on the mobile keyboard, where the connector attaches the mobile keyboard to the computing device, wherein the internal battery powers the computing device through the connector when a battery within the computing device indicates LOW BATTERY.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a backup power keyboard in accordance with an exemplary embodiment of the present invention; and

FIG. 2 depicts a perspective view of a backup power keyboard with a computing device in accordance with an exemplary embodiment of the present invention.

Like reference numerals refer to like parts throughout the description of several views of the drawings.

### DETAILED DESCRIPTION OF THE DRAWINGS

The present invention relates to a keyboard with an independent battery, that when needed by its attached computer is serves as a backup battery. The present invention provides a backup power keyboard to offer a device that extends the battery life of its coordinating electronic device. The backup power keyboard is a mobile keyboard, complimentary to a variety of computing devices including laptop computers, smartphones, and tablet computers. Once the computing device indicates that its power is running low, a sensor in the backup power keyboard activates an internal battery to takeover power for the computing device. With the backup power keyboard the user is able to significantly extend their computing time.

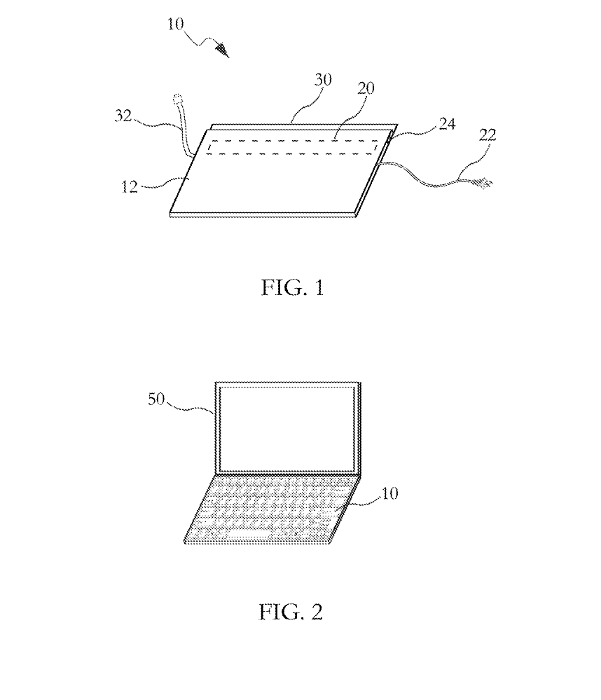

Turning now descriptively to the drawings, referring to FIG. 1, a perspective view of a backup power keyboard 10 is shown in accordance with an exemplary embodiment of the present invention. The backup power keyboard 10 is illustrated without the computer keys for simplicity of illustration. The backup power keyboard 10 includes a mobile keyboard 12 with an internal battery 20. The internal battery 20 is activated once a LOW BATTERY notification is displayed on a computing device. The LOW BATTERY notification may signal the backup power keyboard 10 to automatically activate the internal battery 20 therefore taking over power from the computing device's own battery. The internal battery 20 may be manually activated with an activation button 24 positioned on the mobile keyboard 12. The internal battery 20 is rechargeable with a power cord 22 that plugs into a standard outlet. This way, after both the computing device battery and the internal battery 20 are exhausted the backup power keyboard 10 may be recharged for further use.

The mobile keyboard 12 may include a click-in connection strip 30 to attach the backup power keyboard 10 to the computing device. Alternatively, a connection cord 32 may be attached to the mobile keyboard 12. The connection cord 32 may be plugged into a USB port or power port of the computing device. By utilizing the two connectors the backup power keyboard 10 is able to connect with a variety of different computing devices extending their usage time up to eight hours of continuous use.

Referring now to FIG. 2, a perspective view of the backup power keyboard 10 is shown with the computing device 50. The computing device 50 may be a laptop computer, a tablet computer or a smartphone. By utilizing the backup power keyboard 10 the user is able to significantly extend their computing time therefore prolonging the time required between charging.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A backup power keyboard for a computing device comprising:
a. a mobile keyboard, where the mobile keyboard is connected to the computing device;
b. an internal battery within the mobile keyboard, where the internal battery is rechargeable; and
c. a connector on the mobile keyboard, where the connector attaches the mobile keyboard to the computing device,
wherein the internal battery powers the computing device through the connector when a battery within the computing device indicates LOW BATTERY.

2. The backup power keyboard according to claim 1, where the internal battery is activated automatically once the computing device indicates LOW BATTERY.

3. The backup power keyboard according to claim 1, where the internal battery is activated manually with an activation button on the mobile keyboard.

4. The backup power keyboard according to claim 1, where the connector is a click-in connection strip.

5. The backup power keyboard according to claim 1, where the connector is a connection cord, where the connection cord plugs into a port within the computing device.
